(19) United States
(12) Patent Application Publication
(10) Pub. No.: US 2004/0071323 A1
(43) Pub. Date: Apr. 15, 2004

(54) Data recorder

(76) Inventors: Ara Warkes Darzi, Buckinghamshire (GB); Lee David Edwards, Essex (GB); Sean Mackay, Melbourne (RU); Edward Draper, Buckinghamshire (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/362,618

(22) PCT Filed: Aug. 23, 2001
(86) PCT No.: PCT/GB01/03801

(30) Foreign Application Priority Data
Aug. 23, 2000 (GB) 0020845.4

(51) Int. Cl. G06K 9/00

(52) U.S. Cl. 382/128; 348/77

(57) ABSTRACT

A system for monitoring the execution of a procedure within a predetermined environment comprising means for recording characteristics of the procedure during the time in which the procedure is executed. These can be video, audio, or other data characteristics of the procedure and can be subsequently be accessed for review.

The present invention relates to a system for monitoring the execution of a procedure within a predetermined environment.

It is apparent that patient safety and the monitoring of clinical competence are of ever increasing importance. The impact of clinical negligence, in an extremely litigious environment, is becoming increasingly burdensome to the medical profession and the healthcare industry as a whole.

Equally the medical profession in co-operation with their respective governing bodies and governments are committed to identifying and applying the most effective clinical excellence protocols to the benefit of patient outcomes and clinical environment efficiency.

Typically the operating and clinical environment is equipped with sophisticated equipment, including, but not limited to patient anaesthesia equipment, patient vital sign monitoring, surgical visualisation systems (endoscopic), electro-cautery and dissection systems, and a wide variety of alternative instruments or instrumentation. The clinician and his/her team, including technical staff, have to use and monitor this sophisticated equipment, as well as perform highly dextrous tasks, efficiently communicate and co-ordinate procedures and activities whose margins for error are small.

Typical records of surgical procedure include manuscript notes and forms generally completed and submitted by surgical staff after the operation.

It is desirable to have a fully integrated, real time visual and audio recording, data collection and retrieval system that would offer the medical professions and healthcare industry the benefit of efficient accident reconstruction and identification of potential personnel and equipment weaknesses, for example to aid in the establishment of best practices.

In a preferred embodiment of the invention, there is provided a monitoring system for a clinical or surgical environment, said system being operable to record data from said environment, such as; for example; audio and/or video data; data from clinical and surgical equipment; and a record of movement of personnel in said environment.

The resultant data provides invaluable information that may assist the development of advanced, multi-disciplinary skills training. It also provides information that may enable the identification of clinical best practice and enable the creation of an environment within which it is easier to do something right and harder to do something wrong.

The inclusion of a data interrogation system enables detailed analysis and interrogation of all data recorded creating a unique clinical and surgical environment monitoring and recording system.

An embodiment for the monitoring system is related to one or more of the apparatus and mechanisms by which all activities, including surgical and clinical techniques, vital patient signs and anaesthetic data, key therapeutic and diagnostic equipment settings, equipment performance characteristics and safety checks and indicators, dialogue (including inter-personnel and patient dialogue) together with automatic identification and tracking of the relative positions of all personnel within the clinical or surgical environment are monitored, recorded and interrogated in real-time and stored, for later analysis, within, but not limited to, the operating rooms, delivery suites, anaesthetic rooms, recovery rooms and patient consulting rooms of hospitals, clinics, wards and medical practices.

The invention is defined in its various aspects in the appended claims to which reference should now be made.

Embodiments of the present invention will now be described with reference to the accompanying drawings in which;

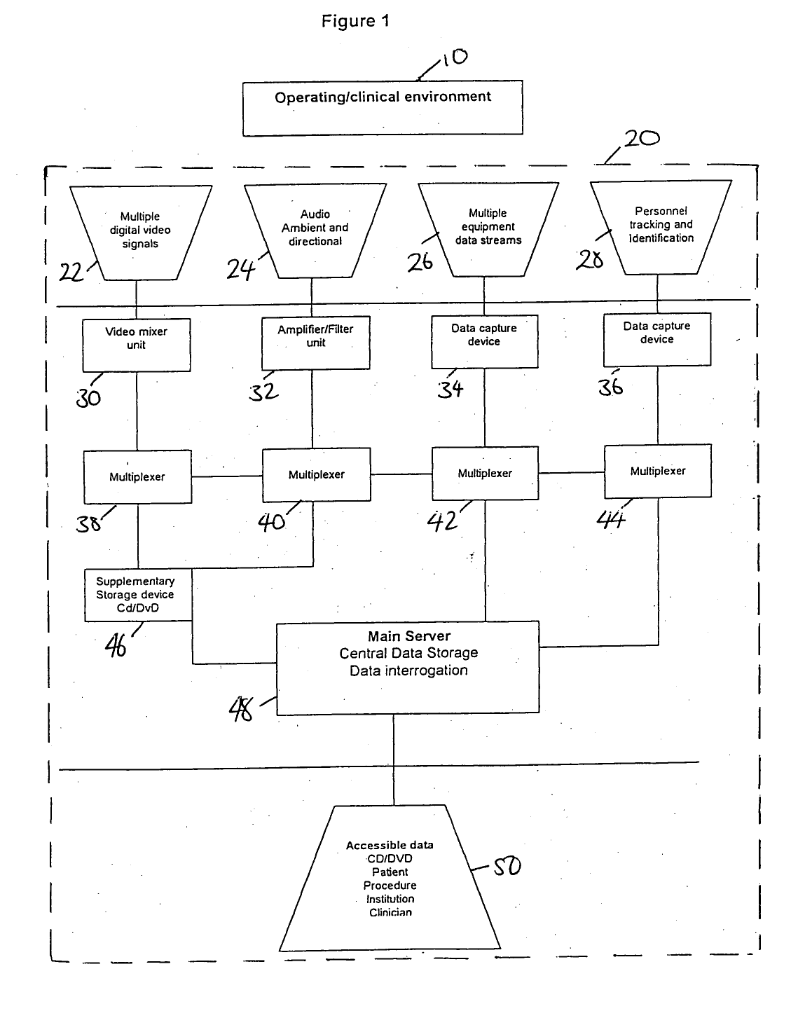

FIG. 1 is a block diagram showing the path of multiple data streams within an embodiment of the present invention;

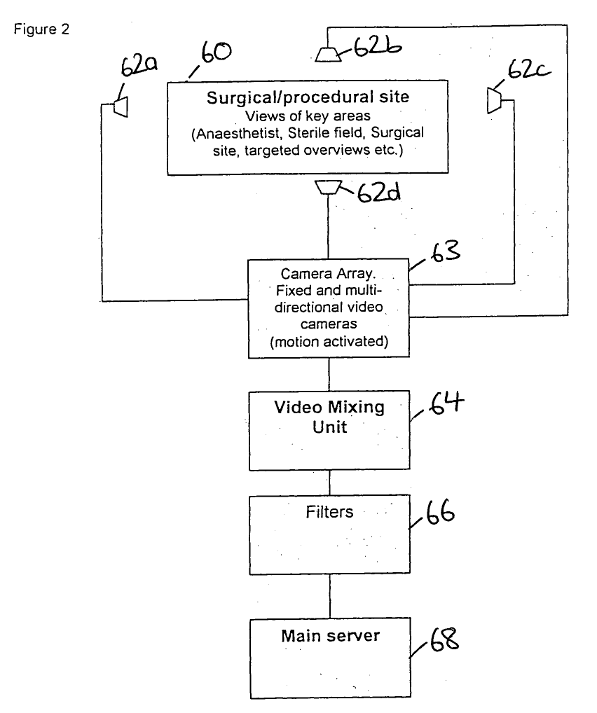

FIG. 2 is a block diagram showing the paths of video data streams within an embodiment of the present invention;

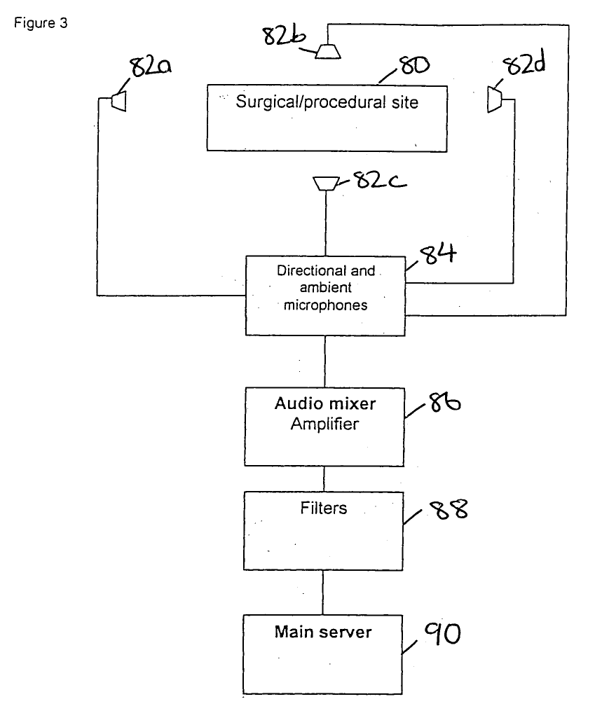

FIG. 3 is a block diagram showing the paths of audio data streams within an embodiment of the present invention;

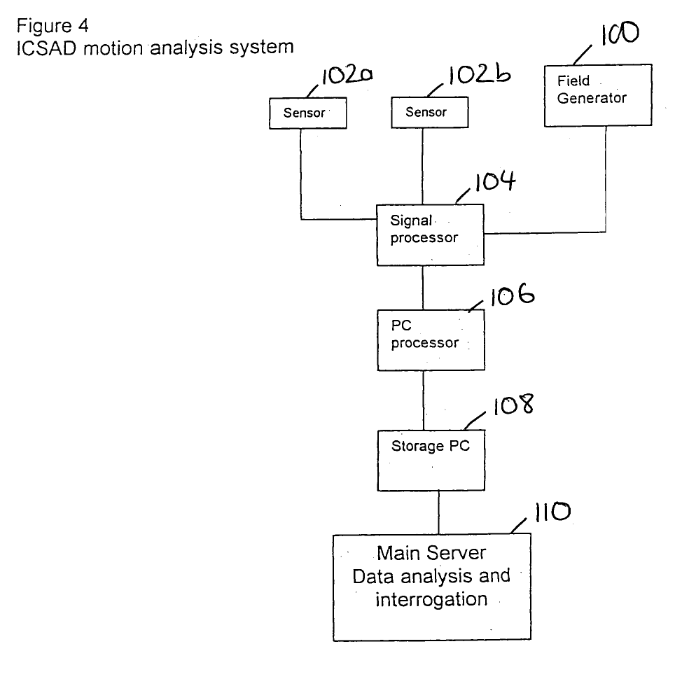

FIG. 4 is a block diagram showing the paths of motion data streams within an embodiment of the present invention;

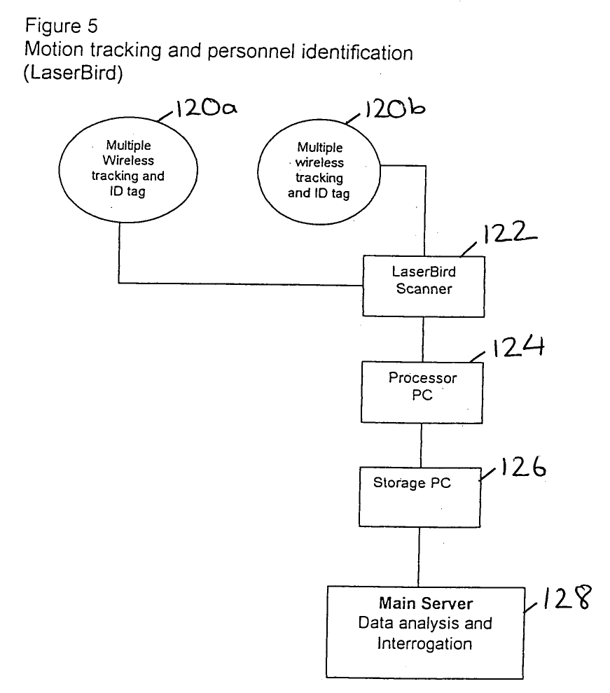

FIG. 5 is a block diagram showing the paths of motion data streams within an embodiment of the present invention;

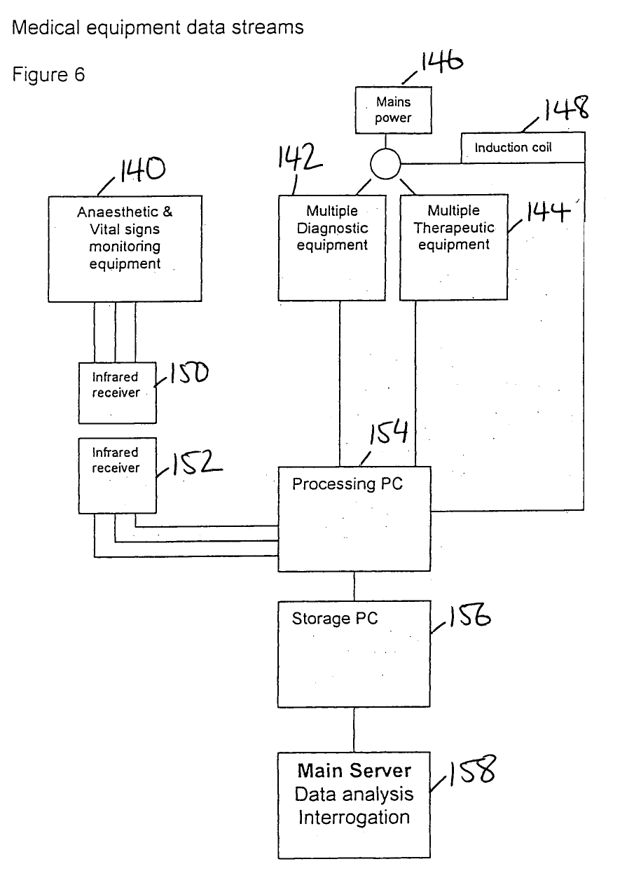

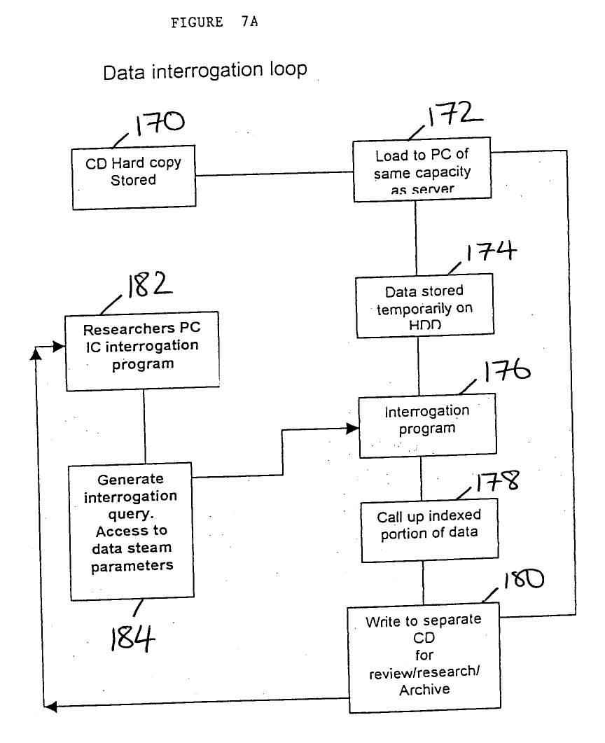

FIG. 6 is a block diagram showing the paths of data streams from medical equipment within an embodiment of the present invention;

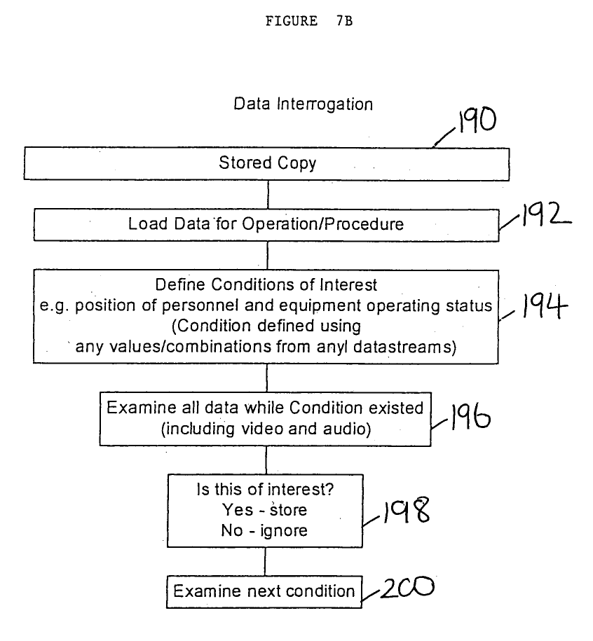

FIG. 7a is a flow diagram showing a data interrogation loop within an embodiment of the present invention;

FIG. 7b is a flow diagram showing data interrogation within an embodiment of the present invention;

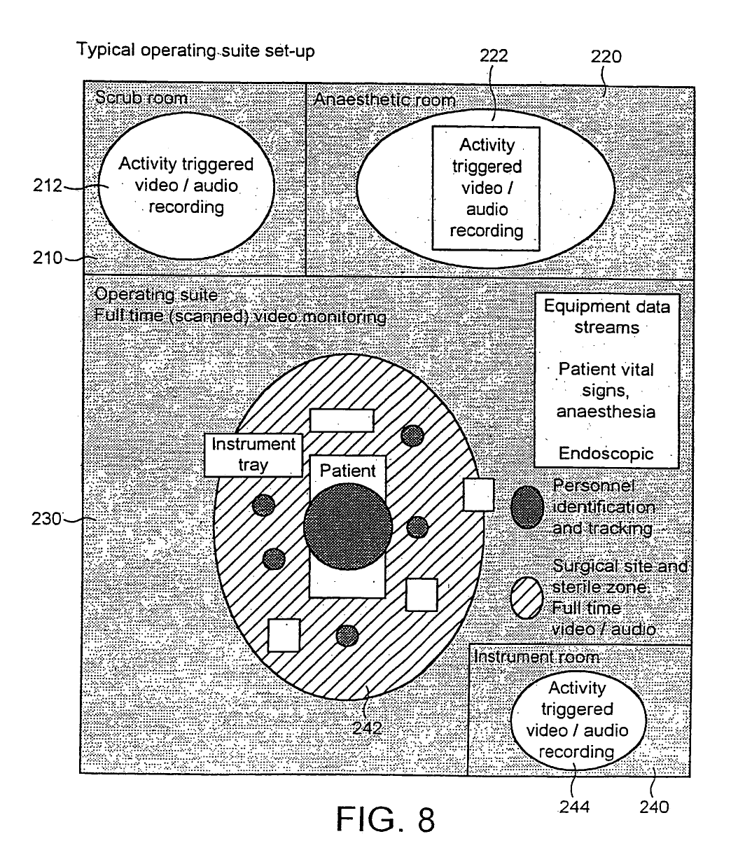

FIG. 8 is a plan of a typical surgical area.

FIG. 1 shows an operating/clinical environment 10 monitored by a clinical data recorder 20. The clinical data recorder 20 includes 4 types of data stream namely multiple digital video signals 22, audio ambient and directional signals 24, multiple equipment data streams 26 and personnel tracking and identification streams 28.

Multiple digital video signals 22 are recorded from multiple video cameras positioned around the monitored area. Multiple video signals are helpful in giving different views of the environment but in some applications only one video signal may be required. Sometimes the video signals are not recorded at all.

At 30 all data streams are channelled through a pre-programmed video mixer unit. The signals are synchronised through a multiplexing system 38 and labelled with a time, date and location id. The synchronisation and labelling of the signals facilitates combination of the multiple data streams. The data streams are forwarded to a supplementary storage device 46, typically CD or DVD. The data streams are then forwarded to the main server 48.

Audio ambient and directional signals are recorded one or more audio receivers 24 positioned around the monitored area. At 32 all data streams are channelled through a an amplifier/filter unit to improve the signal to noise ratio. The signals are synchronised through a multiplexing system 40 and labelled with a time, date and location id. The data streams are then forwarded to a supplementary storage device 46, typically CD or DVD. The data streams are then forwarded to the main server 48.

At 26 the outputs and operating states of one or more pieces of equipment within the operating environment are monitored. The data streams are channelled through a data capture device 34. The signals are synchronised through a multiplexing system 40 and labelled with a time, date and location id. The data streams are then forwarded directly to the main server 48.

At 28 personnel tracking and identification signals for one or more people are recorded which monitor the position of subjects and equipment within the operating environment. The data streams are channelled through a data capture device 36. The signals are synchronised through a multiplexing system 44 and labelled with a time, date and location id. The data streams are then forwarded directly to the main server 48.

The main server 48 is preferably a high capacity digital storage means for example a CD or DVD. The preferred embodiment facilitates access to multiple data streams at 50. A user may access any combination of data streams in order to analyse a particular area of time of the operating proceedings. The labels and synchronisation of all data streams facilitates combination of multiple data streams for review.

The embodiment of FIG. 2 includes only video cameras 62a, 62b, 62c and 62d positioned around the surgical/procedural site 60. One or more video camera can be used. Preferably high resolution digital cameras are used to monitor the surgical site 60. Cameras may be stationary to provide an uninterrupted view of a preferred area or movable to provide constant monitoring of a particular subject. A further embodiment includes a camera installed in the operating or examination light. Mobile cameras can also be used. Motion activated cameras can be provided to monitor areas of low activity. The cameras can be wireless.

Cameras can be programmed with default settings for recording regular operations. In this case, when commencing a particular operation the cameras automatically default to a specific angle or focal length. For example a different default setting can be used for orthopaedic surgery, laparoscopic surgery or neurosurgery.

All of the data streams from the cameras are channelled through a video mixing unit 64 where they are synchronised and labelled with a time, date and id number. At 66 the camera signals are filtered to increase the picture resolution. The filtered signals are forwarded to the main server 68 where they there are stored.

The embodiment of FIG. 3 includes a plurality of audio receivers positioned to monitor a surgical/procedural site 80. One or more microphones are used and these may be tuned to monitor preferred frequencies. The microphones can be stationary to provide an uninterrupted recording of a preferred area or mobile to record the audio output from a subject. Microphones can be attached to preferred subjects to increase the clarity of inter-personnel communications. These will continue to monitor audio signals outside the surgical environment where the inclusion of patient-practitioner communications may be equally important.

Data streams from all microphones are digitally labelled with time, microphone number and position to facilitate data synchronisation and combination.

All of the audio data signals are channelled through an audio mixer 86 which includes an amplifier. Signals are also synchronised and labelled with the time, date and id code at 86. At 88 the signals are filtered to increase the signal to noise ratio. The signals are forwarded to the main server 90 for storage.

The embodiment of FIG. 4 includes a motion analysis system. An example of such a system is the Imperial Surgical Assessment Device ICSAD, UK publication No. GB 2333882. ISCAD is a system for assessing surgical technique by the application of the principles of motion psychology. Sensors are be connected to a surgeon's hands or instruments to monitor movement.

In addition personal identification are worn which allow identification of all personnel within the operating environment. The tags identify the name, position and classification of the individual.

The embodiment of FIG. 4 includes a field generator 100 and multiple sensors 102a and 102b. The sensors may be positioned on subjects or equipment and digitally labelled e.g. by name or id number. The motion analysis system enables the interactions and relative positions of the sensors to be accurately monitored.

The signals from the sensors are forwarded to the signal processor 104. At the signal processor the movements and positions of the sensors within the monitored environment are interpreted. The signals are forwarded to a pc processor 106 where they are synchronised and labelled. The signals are further forwarded to a storage pc 108 and subsequently forwarded to the main server 110.

FIG. 5 shows an embodiment of the present invention including a known LaserBird wireless optical tracking system. The system includes multiple wireless sensors 120a and 120b. Signals from the sensors 120a and 120b are fed into the Laserbird scanner 122.

The signals are forwarded to the processor pc where the positions and movements of the sensors are registered. The signals are forwarded to the storage pc 126 where they are synchronised and labelled before being forwarded to the main server 128 for storage.

FIG. 6 shows a preferred embodiment of the present invention in which equipment used during an operation is monitored.

Features such as anaesthetic, administered and vital signs are monitored at 140. These data streams include cardiac, pulmonary, metabolic and physiologic information and are forwarded to an infrared emitter at 150. The data is transmitted from the infrared emitter 150 to the infrared receiver 152 and forwarded to the processing pc 154. The benefits of using infrared links include avoiding potential current leakage and interference with clinical devices.

Diagnostic equipment 142 is usually mains powered at 146. Data streams from these devices are forwarded to the processing pc 154. The data streams are synchronised and labelled with date, time and id code. Data streams include information identifying the operating status of the equipment or system (either on or off and the relevant outputs of the device). These data streams provide information including incorrect and unsafe pre-operative settings, calibration, misuse and inadvertent use.

Multiple therapeutic equipment 144 are mains powered at 146. Data streams from these devices are forwarded to the processing pc 154. The data streams are synchronised and labelled with date, time and id code. These data streams provide information including incorrect and unsafe pre-operative settings, calibration, misuse and inadvertent use.

The signals from the processing pc 154 are forwarded to a storage pc 156 and further forwarded to the main server 158 for storage.

FIG. 7a shows a system for the interrogation and analysis of data from the main server in an embodiment of the invention. The data from a particular operation or procedure is stored on a CD at 170. At 172 the data is downloaded onto a PC and stored temporarily on the hard drive at 174. At 176 the interrogation program commences. At 178 the user can specify the preferred portion of data for review. Any combination of data can be accessed; for example a user may wish to retrieve data from a single camera, synchronised audio and visual data or data from multiple sensors taken at a particular time. The selected data is retrieved from the data base and written to a separate data storage means at 180.

The data storage means containing the selected data is then downloaded onto a further pc at 182. The data can then be further selected or reviewed via the pc at 184.

FIG. 7b shows the data interrogation procedure. The data from a particular operation or procedure is stored at 190. At 192 the data is downloaded onto a further data reviewing means. At 194 the user may select the conditions of interest for review. The condition is defined using any combination of the data streams. Examples include positions of personnel only, video data streams, audio data, instrumentation data or any further data streams. Therefore, the user is able to examine a particular time frame, area, individual or instrument at 196. The user has the option to store the information in a further storage source at 198. At 200 the user may examine a further condition.

FIG. 8 shows a plan of a typical operating theatre. The areas monitored by an embodiment of the invention are indicated. The suite contains 4 main areas namely the scrub room 210, anaesthetic room 220, operating suite 230 and instrument room 240. The scrub room 210 is an area of low activity during the operation and is monitored by video and audio recording means 212 which are triggered by activity. The anaesthetic room 220 is also an area of low activity and is also monitored by activity triggered video and audio recording equipment 222.

The operating suite 230 is an area of high activity. This area is monitored by video cameras. The sterile surgical site 242 within the operating suite is the area where the operation proceeds, this area is monitored using full time audio and video sensors.

The operating suite contains a patient and multiple surgical staff. Each of these subjects wears a personal identification and tracking device. These devices allow the movements of the subjects to be constantly monitored. The surgical site further includes multiple surgical equipment. The data streams from these equipment are recorded and stored in the main server.

The instrument room 240 is an area of low activity and is monitored by activity triggered video and audio recording equipment 244.

It is clear from the above description that preferred embodiments of the present invention provide a system for comprehensively monitoring a particular environment. The synchronisation, combination and storage of multiple data streams facilitate real time recording and enable a particular operation or procedure to be analysed at a later time by downloading the stored data.

It is understood that the methods employed by the present invention extend beyond medical practice and facilitate a means for monitoring of a variety of environments. When monitoring a preferred environment, sensors and data streams suitable for use in that environment should be employed.

1. A system for monitoring the execution of a procedure within a predetermined environment comprising means for recording multiple characteristics of the procedure during the time in which the procedure is executed wherein the characteristics of the procedure are recorded from multiple sources and the characteristics include the position, movement and identity of the subjects within the environment which are monitored by positioning sensors on the subjects and monitoring the movement of the sensors.

2. A system for monitoring the execution of a procedure within a predetermined environment according to claim 1 in which multiple data streams from the multiple sources are channelled, synchronised, labelled and stored on a storage facility, the storage facility providing the retrieval of any combination of data streams.

3. A system for monitoring the execution of a procedure within a predetermined environment according to claim 1 or 2 in which the position of equipment is monitored.

4. A system for monitoring the execution of a procedure within a predetermined environment according to claim 1, 2 or 3 in which the characteristics of the procedure comprise visual information and are recorded using cameras.

5. A system for monitoring the execution of a procedure within a predetermined environment according to claim 1, 2, 3 or 4 in which the characteristics of the procedure comprise audio information and are recorded using audio receivers.

6. A system for monitoring the execution of a procedure within a predetermined environment according to claim 1, 2, 3, 4 or 5 in which the characteristics of the procedure comprise the status of instrumentation used during the procedure.

7. A system for monitoring the execution of a procedure within a predetermined environment according to claim 1, 2, 3, 4, 5 or 6 in which recorded data may be selected and downloaded.

8. A system for monitoring the execution of a procedure within a predetermined environment substantially as herein described, with reference to the accompanying drawings.

9. A method for monitoring the execution of a procedure within a predetermined environment including the steps of recording multiple characteristics of the procedure during the time in which the procedure is executed wherein the characteristics of the procedure are recorded from multiple sources and including the further step of positioning sensors on the subjects and monitoring the movement of the sensors positioned on the subjects.

10. A method for monitoring the execution of a procedure within a predetermined environment according to claim 9 including the further steps of channelling, synchronising, labelling and storing multiple data streams from the multiple sources on a storage facility, the storage facility providing the retrieval of any combination of data streams.

11. A method for monitoring the execution of a procedure within a predetermined environment according to claim 9 or 10 including the step of monitoring the position of equipment.

12. A method for monitoring the execution of a procedure within a predetermined environment according to claim 9, 10 or 11 in which the characteristics of the procedure comprise visual information and are recorded using cameras.

13. A method for monitoring the execution of a procedure within a predetermined environment according to claim 9, 10, 11 or 12 in which the characteristics of the procedure comprise audio information and are recorded using audio receivers.

14. A method for monitoring the execution of a procedure within a predetermined environment according to claim 9, 10, 11, 12 or 13 in which the characteristics of the procedure comprise the status of instrumentation used during the procedure.

15. A method for monitoring the execution of a procedure within a predetermined environment according to claim 9, 10, 11, 12, 13 or 14 in which stored data may be selected and downloaded.

16. A method for monitoring the execution of a procedure within a predetermined environment substantially as herein described, with reference to the accompanying drawings.

17. A machine readable data carrier storing data recorded thereon by the method of any of claims 8 to 14.

18. An apparatus for accessing data recorded according to the method of any of claims 9 to 16.

19. An apparatus according to claim 18 in which more than one data stream can be accessed simultaneously and in synchronism.
